(19) United States
(12) Patent Application Publication
(10) Pub. No.: US 2011/0218845 A1
(43) Pub. Date: Sep. 8, 2011

(54) Interactive Advertising for Computer Mediated Communications

(76) Inventor: Maria Medina, San Antonio, TX (US)

(21) Appl. No.: 12/718,856

(22) Filed: Mar. 5, 2010

(51) Int. Cl. G06Q 30/00

(52) U.S. Cl. 705/14.11; 705/14.55

(57) ABSTRACT

A system, method, and computer program product are provided for interactive advertising for computer mediated communications. An advertisement associated with an advertiser is provided by a communication service provider to a user of the communication service provider. A selected advertisement is associated with a user communication by the communication service provider in response to a user selection to associate the advertisement with the user communication. Compensation from the advertiser associated with the selected advertisement is received for the communication service provider in response to a determination that a recipient of the user communication committed an action associated with the selected advertisement.

### CROSS REFERENCE TO RELATED APPLICATIONS

Not applicable

### STATEMENT REGARDING FEDERALLY SPONSORED RESEARCH OR DEVELOPMENT

Not applicable

### REFERENCE TO MICROFICHE APPENDIX

Not applicable

### FIELD OF THE PRESENT DISCLOSURE

The present invention relates generally to interactive advertising and more particularly to creating interactive advertisements to promote sales of products and services via computer mediated communications.

### BACKGROUND

The Internet has revolutionized communication for individuals and groups of individuals. Individuals can communicate through the Internet computers, such as desktop computers, laptop computers, and mobile phone computers. Individuals can form networked groups via the Internet easily and without necessarily knowing each other in advance. Networked groups of individuals with common interests can span geographic locations and time. Group interactions may the facilitated by various online tools that enable multiple users to communicate among themselves.

Social network services have become one of the most popular forms of group communication, attracting hundreds of millions of users around the world, many of whom have integrated the use of such services into their daily activities. A social network service may utilize a web-based site that enables users to create public or semi-public profiles, organize lists of other users with whom they share a connection, and communicate with other users within the social network site's system. Social network sites may offer different communication tools that include the ability to post text messages at a website, send private messages, upload photos and videos, and provide links to other websites. The popularity of social network sites has been facilitated by the business practice of many social network sites of offering their services at no charge to their users. However, a social network site offering a free or low-cost service lends itself to the challenge of generating revenue for the social network site. Without a solid business model that will generate profits, these social network sites may be unable to sustain themselves. To address these challenges, many social network sites have turned to interactive advertising.

Interactive advertising includes the paid presentation and promotion of products, services, and ideas using the Internet as the medium by which consumers and advertisers can interact. Current formats of interactive advertising include search, display (banner advertisements), sponsorship, email, lead generation, classifieds and auctions, rich media, and digital video commercials. A main advantage of interactive advertising is that some user interactions with the advertisements, such as advertisement impressions, selections or click-throughs, and purchases, may be tracked. This tracking data may provide an advertiser with feedback on the effectiveness of its advertisements. The primary challenge of interactive advertising systems is to customize and target advertisements in a manner that increases their relevance and effectiveness. Many online advertising systems focus on the use of data mining to customize and target advertisements to consumers. The benefit of this approach to advertisers is to concentrate efforts on prospective customers who are predicted to have a high likelihood of responding to an advertisement.

### SUMMARY

The use of data milling for interactive advertising has some challenges to overcome. The effective use of data mining techniques is more difficult in promoting advertisements to new users because significantly large amounts of data are needed to define trends and identify patterns. Additionally, some consumers may protest against data collection techniques if they believe that this process constitutes a breach of their privacy. Furthermore, the time and resources required to compile and analyze the data may not be proportionate with the results.

A system, method, and computer program product are provided for interactive advertising for computer mediated communications. Although the present disclosure describes social network sites that enable communications via the Internet and/or mobile device applications, embodiments of the present disclosure may use other types of communication service providers that enable communications via other types of communication networks. A user of a social network site uses the site to communicate a recommendation for a service or a product, such as a vacuum cleaner, and selects an option presented by the site to review sponsored ads, such as an ad for the vacuum cleaner recommended by the user. In contrast to privacy concerns about users' data being misused to select ads for presentation to the users, the users of the social network site select the ads themselves. When a user selects an ad, such as the vacuum cleaner ad, to be associated with the user's communication, the social network site associates the user's communication with the user-selected ad. A set consisting of a user's communication and the user-selected ad may be considered as an advertisement different from the user-selected ad and may be referred to as a “user-ad.” In contrast to data mining techniques, which may expend significant resources to accumulate large amounts of data in an attempt to predict which users may have a high likelihood of responding to an advertisement, a user of a social network site may select recipients based on personal knowledge of which potential recipient may be most likely to appreciate and respond to a user-ad. Furthermore, the friends of a social network site user may trust their friends' advertisements more than they trust conventional commercial advertisements. After a recipient of a user-ad responds by interacting with the user-ad, such as by requesting to view the user-selected ad for the vacuum cleaner, clicking or selecting the user-selected ad for the vacuum cleaner, or making a purchase via the user-selected ad for the vacuum cleaner, the social network site receives compensation from the advertiser sponsoring the user-selected ad, such as the advertiser of the vacuum cleaner ad. The site may forward a portion of the compensation to the user who selected the ad, such as the vacuum cleaner ad, to be associated with the user's communication, such as the user's recommendation for the vacuum cleaner. Embodiments of the present disclosure provide interactive advertising that is consistent with the intended use of social network sites because users utilize such sites to enhance their interactions with other site users.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 presents a sample system of the present disclosure;

FIG. 2 presents a sample frame of a display screen presented by a user interface of the present disclosure;

FIG. 3 presents a sample frame of another display screen presented by a user interface of the present disclosure;

FIG. 4 presents a sample frame of yet another display screen presented by a user interface of the present disclosure;

FIG. 5 presents a sample frame of yet another display screen presented by a user interface of the present disclosure;

FIG. 6 presents a sample frame of yet another display screen presented by a user interface of the present disclosure;

FIG. 7 presents a sample frame of yet another display screen presented by a user interface of the present disclosure;

FIG. 8 presents a sample frame of yet another display screen presented by a user interface of the present disclosure;

FIG. 9 presents a sample frame of yet another display screen presented by a user interface of the present disclosure;

FIG. 10 presents a sample frame of yet another display screen presented by a user interface of the present disclosure;

FIG. 11 presents a sample frame of yet another display screen presented by a user interface of the present disclosure;

FIG. 12 presents a sample frame of yet another display screen presented by a user interface of the present disclosure;

FIG. 13 presents a sample frame of yet another display screen presented by a user interface of the present disclosure;

FIG. 14 presents a sample frame of yet another display screen presented by a user interface of the present disclosure;

FIG. 15 presents a sample method of the present disclosure; and

FIG. 16 illustrates an exemplary computer system suitable for implementing the several embodiments of the disclosure.

### DETAILED DESCRIPTION OF SOME EMBODIMENTS

It should be understood at the outset that although illustrative implementations of one or more embodiments are illustrated below, the disclosed systems and methods may be implemented using any number of techniques, whether currently known or in existence. The disclosure should in no way be limited to the illustrative implementations, drawings, and techniques illustrated below, but may be modified within the scope of the appended claims along with their full scope of equivalents.

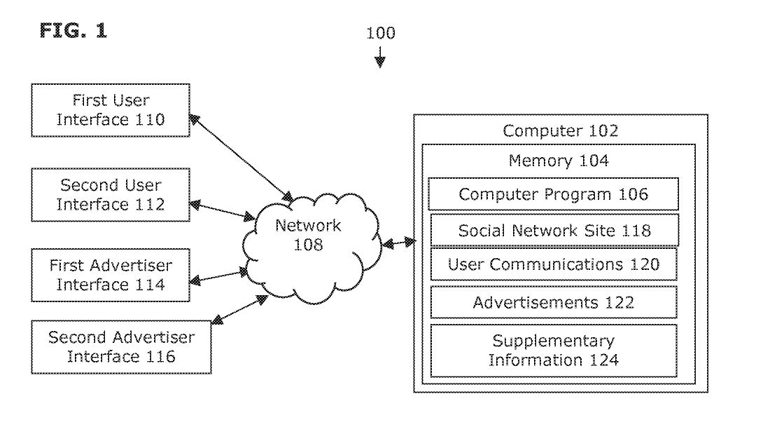

FIG. 1 presents a sample system 100 of the present disclosure. The system 100 includes a computer 102, a memory 104, a computer program 106, a network 108, a first user interface 110, a second user interface 112, a first advertiser interface 114, and a second advertiser interface 116. The computer program 106 is stored in the memory 104 and executed by the computer 102 to communicate with the user interfaces 110-116 via the network 108. Although in some embodiments of the present disclosure the network 108 may be the Internet, in other embodiments of the present disclosure the network 108 may be any other interactive, electronic, broad based audio-visual communication medium that utilizes computers to mediate communications.

Although FIG. 1 depicts that the memory 104 may also include a social network site 118 or site 118, user communications 120, advertisements 122 or ads 122, and supplementary information 124, the elements 118-124 may reside in a separate data storage (not depicted in FIG. 1) or any combination of the elements 118-124 may reside in any combination of the memory 104 and the separate data storage. The computer 102 may receive the ads 122 from the advertiser interfaces 114 and 116. Although FIG. 1 depicts one of each of the elements 102-124, the system 100 may include any number of each of the elements 102-124, as well as additional elements that are not depicted in FIG. 1. The user interfaces 110-116 provide access for users and advertisers. Access may be based on acceptance of access-enabling information, such as user identifications and passwords, input via the user interlaces 110-116.

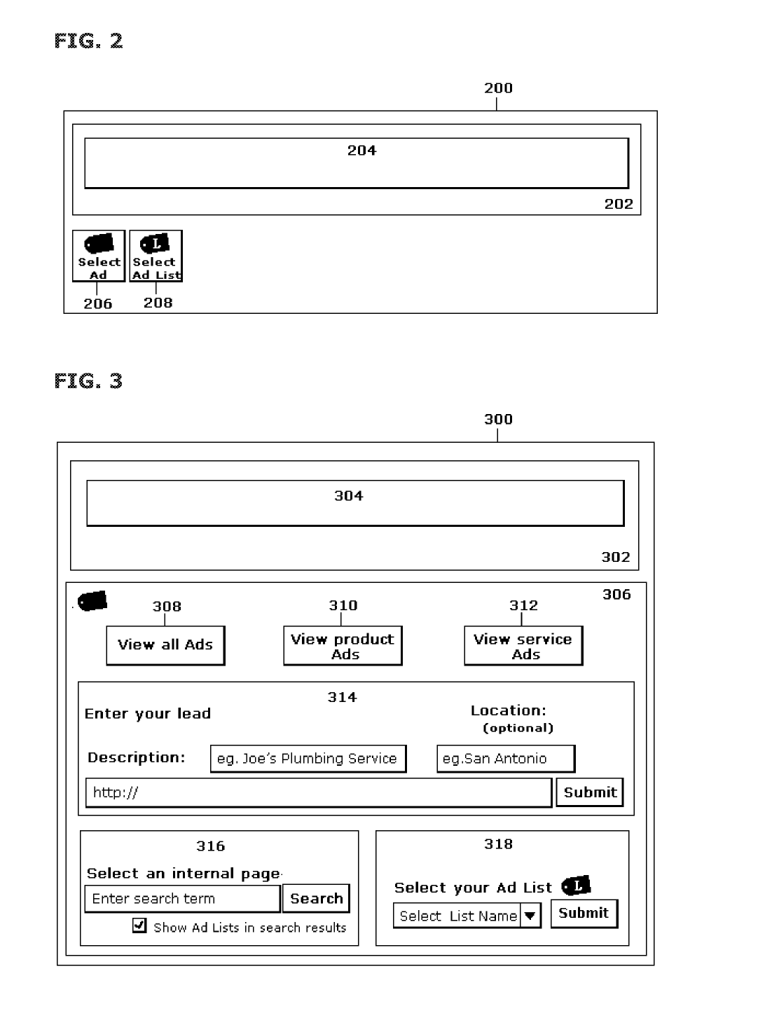

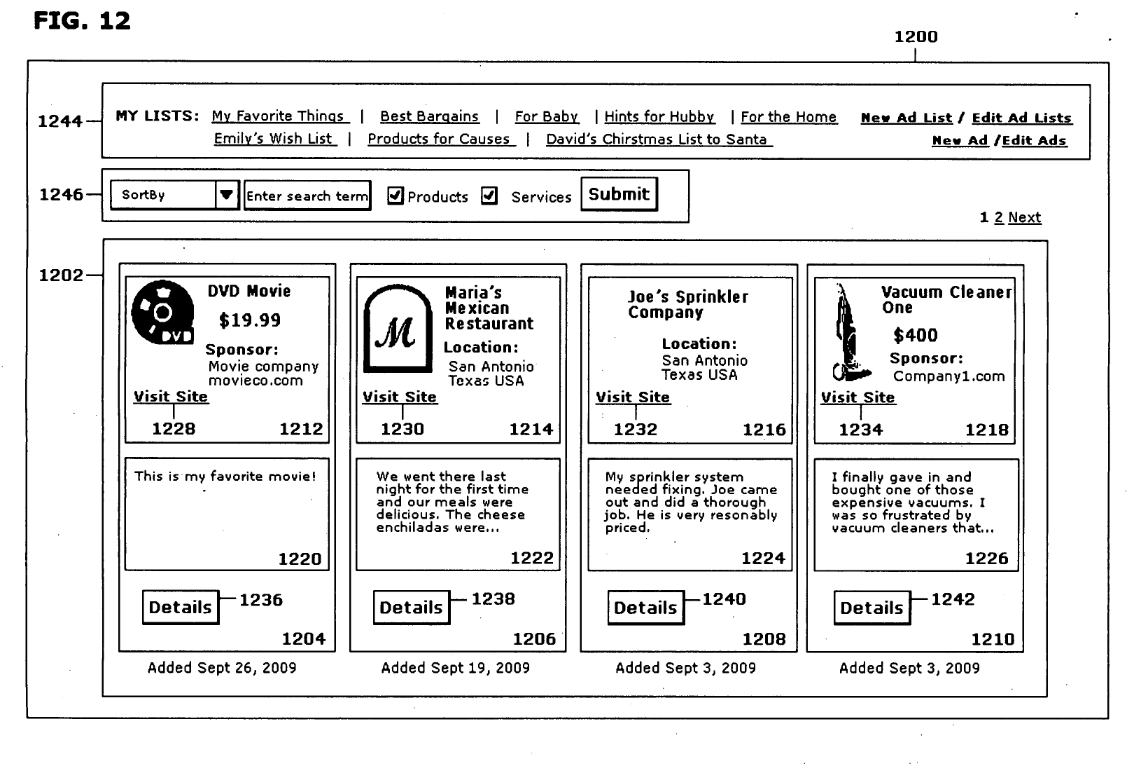

FIG. 2 presents a sample frame 200 of a display screen presented by the first viewer user interface 110 of the present disclosure. The frame 200 includes a communication section 202, a communication field 204, a select ad option 206, and a select ad list option 208. The site 118 may receive a user request to review the ads 122. For example, a user named Maria uses the site 118 to enter a communication about a vacuum cleaner in the communication field 204 to recommend the vacuum cleaner to her social network contacts and/or other users of the site 118. Although a user may enter text communication in the communication section 202, the user may submit audio files and/or video files and/or other audio-visual file types via the communication section 202. Continuing this example, Maria selects the select ad option 206 presented by the site 118 to review the ads 122, which may include an ad for the vacuum cleaner of interest to her. Alternatively, the site 118 may prompt a user with an option to review the ads 122. For example, the site 118 responds to a determination that Maria entered the text “vacuum cleaner” in the communication field 204 by prompting her with an option to review the ads 122 and/or ads related to vacuum cleaners. Although the present disclosure illustrates two methods for a user to be provided with selectable ads sponsored by advertisers, other methods for ad provision will suggest themselves to those of skill in the art. The select ad list option 208 is related to user-ad lists, which are discussed in detail below in reference to FIG. 12.

FIG. 3 presents a sample frame 300 of a display screen presented by the first viewer user interface 110 of the present disclosure. The frame 300 includes a communication section 302, a communication field 304, an ad section 306, a view all ads option 308, a view product ads option 310, a view service ads option 312, an enter a lead section 314, a select an internal page section 316, and a select your ad list section 318. The first viewer user interface 110 may respond to the selection of the select ad option 206 in FIG. 2 by displaying the frame 300.

A user may enter a communication in the communication field 304 after selecting the select ad option 206, the communication field 304 may include the communication that the user previously entered in the communication field 204 in FIG. 2, or the user may not enter a communication in the communication sections 202 or 302. Although the communication sections 202 and 302 may enable a user to enter text communication, the user may submit audio files, video files, and/or other audio-visual file types via the communication sections 202 in FIG. 2 and/or the communication section 302 in FIG. 3.

The ad section 306 enables the selection of an ad by a user. A user may select an ad by selecting the view all ads option 308, the view product ads option 310, and/or the view service ads option 312 to select one of the ads 122 offered by the site 118. For example, Maria selects the view product ads option 310 because she has identified the vacuum cleaner she wants to recommend as a product. Alternatively, a user may select the view service ads option 312 because the user has identified the topic of the user's communication as a service or the user may select the view all ads option 308 because the user is unsure if the topic of the user's communication is classified as a product or a service. For example, Maria may be unsure whether a pizza restaurant that specializes in the delivery of pizzas is sponsoring a product ad for the pizza or a service ad for the delivery of the pizza. Alternatively, a user may select the view all ads option 308 when the user has not yet determined the topic of the user's communication. For example, Maria reviews the ads 122 to determine if she wants to make a recommendation for one or more of the ads 122.

Alternatively, a user may select an ad by entering the ad information, such as a name of a business and the business' website, via the enter a lead section 314. A user may enter a name of a business, a name of an individual providing a service, a name of a web page, a description of a web page, contact information such as a phone number and/or street address, a geographic location, and/or other ad information in the enter a lead section 314. For example, Maria may chose a web page where her friends can purchase the vacuum or she might chose a web page with a review about this particular vacuum or about vacuums in general. Although such a user-selected ad may not be a sponsored ad that generates compensation for the site 118 directly and/or a user indirectly, the option to associate such a user-selected ad with the user's communication may enhance the user's use of the social network site 118.

Alternatively, a user may select an ad by selecting a web page that is internal to the social network site 118 via the select an internal page section 316. For example, Maria may chose to associate her communication with a web page offered by the site 118 for a networked group of satisfied consumers. Although such a user-selected ad may not be a sponsored ad that generates compensation for the site 118 directly and/or a user indirectly, the option to associate such a user-selected ad with the user's communication may enhance the user's use of the site 118. Alternatively, a user may select an ad list to be associated with the user's communication via the select your ad list section 318. The select your ad list section 318 is related to ad lists, which are discussed iii detail below in reference to FIG. 12,

A user-ad represents an advertisement that is different from the original user-selected ad and may be distinguished from the original user-selected ad by the addition of a user's communication and/or a determination by a user for the display and/or use of the user-ad at the site 118. Elements of the display of and/or the communication processing of a user-ad may be determined by the user. For example, if a user did not enter a communication but selected an ad and followed a process to communicate the selected ad to one or more users of the social network site 118, the selected ad communicated by the user may be considered a “user-ad,” As discussed previously, a user may determine the content type of a selected ad by selecting an ad sponsored by an advertiser, entering the ad information, selecting a page that is internal to the social network site 118, or selecting an ad list, which are discussed in detail below in reference to FIG. 12. A user may select a method of communication for a user-ad, such as a display of the user-ad at a user selected web page that is internal to the social network site 118 and/or a display of the user-ad within an individual communication sent from within the site 118 from the user to a different user of the site 118 and/or an alternative method of communication provided by the site 118. A user may select the potential recipients of a user-ad, such as the user's network of contacts with the social network site 118 and request the site 118 to send a communication containing the user-ad to the user's selected recipients. Alternatively or additionally, a user may select a privacy setting for a display of a user-ad at a web page within the site 118 that determines which users of the site 118 can receive a display of the user-ad.

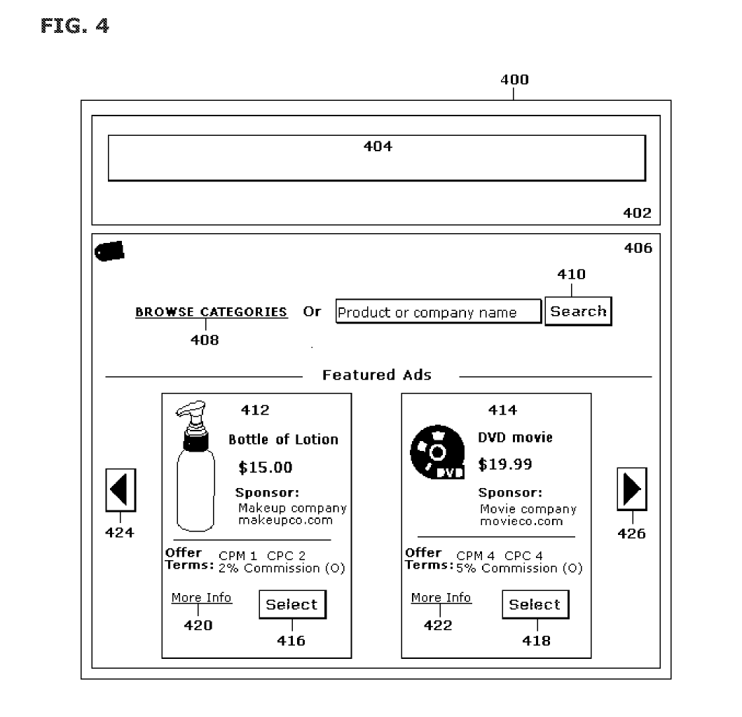

FIG. 4 presents a sample frame 400 of a display screen presented by the first viewer user interface 110 of the present disclosure. The frame 400 includes a communication section 402, a communication field 404, an ad section 406, a browse categories option 408, a search option 410, ad display sections 412 and 414, select ad options 416 and 418, more info options 420 and 422, a navigate option 424, and a navigate right option 426. The first viewer user interface 110 may respond to the selection of the view product ads option 308 in FIG. 3 by displaying the frame 400. A user may enter a text communication in the communication field 404 after selecting the view product ads option 310, or the communication section 402 may include the communication that the user previously entered in the communication section 202 in FIG. 2 or communication section 302 in FIG. 3. Although the communication sections 202, 302, and 402 may include text communication, a user may submit audio files, video files, and/or other audio-visual file types via the communication sections 202, 302, and/or 402.

When a user selects the browse categories option 408, the first viewer user interface 110 may respond by presenting a hierarchy of ad categories and sub-categories options to assist the user in reviewing the ads 122. For example, the first viewer user interface 110 may present yet another frame (not depicted in FIG. 4) that presents general categories for the advertisements 122, such as the general categories of children, cars, clothing, electronics, health, home, music, pets, telephones, toys, and other products. When a user selects one of the general categories, such as “home,” the first viewer user interface 110 may present an additional frame (not depicted in FIG. 4) that presents sub-categories for the advertisements 122, such as the sub-categories for “home,” such as appliances, bathroom, bedroom, food, furniture, housecleaning, kitchen, lawn, lighting, sporting goods, tools, and other products. When a user selects one of the sub-categories, such as “housecleaning,” the first viewer user interface 110 may present yet an additional frame (not depicted in FIG. 4) that presents sub-categories for the sub-categories for the ads 122, such as the sub-categories for “housecleaning,” such as cleaning products, dishwashers, laundry, vacuums, washers, windows, and other products.

Alternatively, the first viewer user interface 110 may present a first “pop-up” window (not depicted in FIG. 4) within the context of frame 400 that presents the general categories for the ads 122. Continuing this example, the first viewer user interface 110 may respond to the selection of a general category from the first “pop-up” window by presenting a second “pop-up” window (not depicted in FIG. 4) within the context of the frame 400 that presents sub-categories for the ads 122. Further to this example, the first viewer user interface 110 may respond to the selection of a sub-category from the second “pop-up” window by presenting a third “pop-up window (not depicted in FIG. 4) within the context of the frame 400 that presents sub-categories for the sub-categories for the ads 122. Although the present disclosure illustrates the process of category selection through three levels of categories and sub-categories depicted by separate frames and “pop-up” windows within a single frame, embodiments of the present disclosure may use any number of categories and sub-categories, and other methods of category selection will suggest themselves to those of skill in the art.

When a user requests a search via the search option 410, the first viewer user interface 110 may respond by presenting the ads 122 that correspond to any user-entered search terms, such as a specific product's name, a specific advertiser's name, a category name, or an “ad identifier.” An ad identifier may be a unique identifier that corresponds to each individual ad. An advertiser may encourage current and potential customers and/or other interested parties to select the advertiser's ads by promoting the ad identifiers via the advertiser's website and/or the advertiser's pages within the social network site 118 and/or any other promotional material such as printed ads, banner ads, Hogs, newsletters, and television commercials. Ad identifiers may be used by an advertiser and/or any other interested parties within or without the network 108. For example, an ad identifier may be used within the network 108 as a component of a link directing a user to the site 118. When a user clicks or selects the link containing the ad identifier, the site 118 may identify the ad identifier component of the link and determine the ad corresponding to the ad identifier. A user may be shown a frame similar to the frame 400 in which the identified ad may be displayed in a format similar to the ad display section 412 in FIG. 4. An example of a use for ad identifiers without the network 108 is an advertiser displays the ad identifiers on a printed receipt given to a customer who has bought the products and/or services associated with the ad identifiers. By providing a quick and easy way to identify a sponsored ad, an advertiser may avoid having a user review the ads 122 offered by competitors and potentially select one of the competitors' ads. An advertiser may provide additional compensation to the social network site 118 for the utilization of customized ad identifiers. For example, an advertiser may want to use the advertiser's name or the advertiser's initials as a component of the ad identifier and may want to further exclude other advertisers from using ad identifiers that contain similar letters.

The ad display sections 412 and 414 are for featured advertisements. An advertiser may provide additional compensation to the social network site 118 to prominently display the ad display sections 412 and 414 in the frame 400 and/or other frames within the site 118. A user may select the select ad options 416 and/or 418 to select the corresponding featured ad as the user-selected ad. A user may select the more info options 420 and 422 to receive additional information about the corresponding featured ads. A user may select the navigate left option 424 and/or the navigate right option 426 to view additional featured ads.

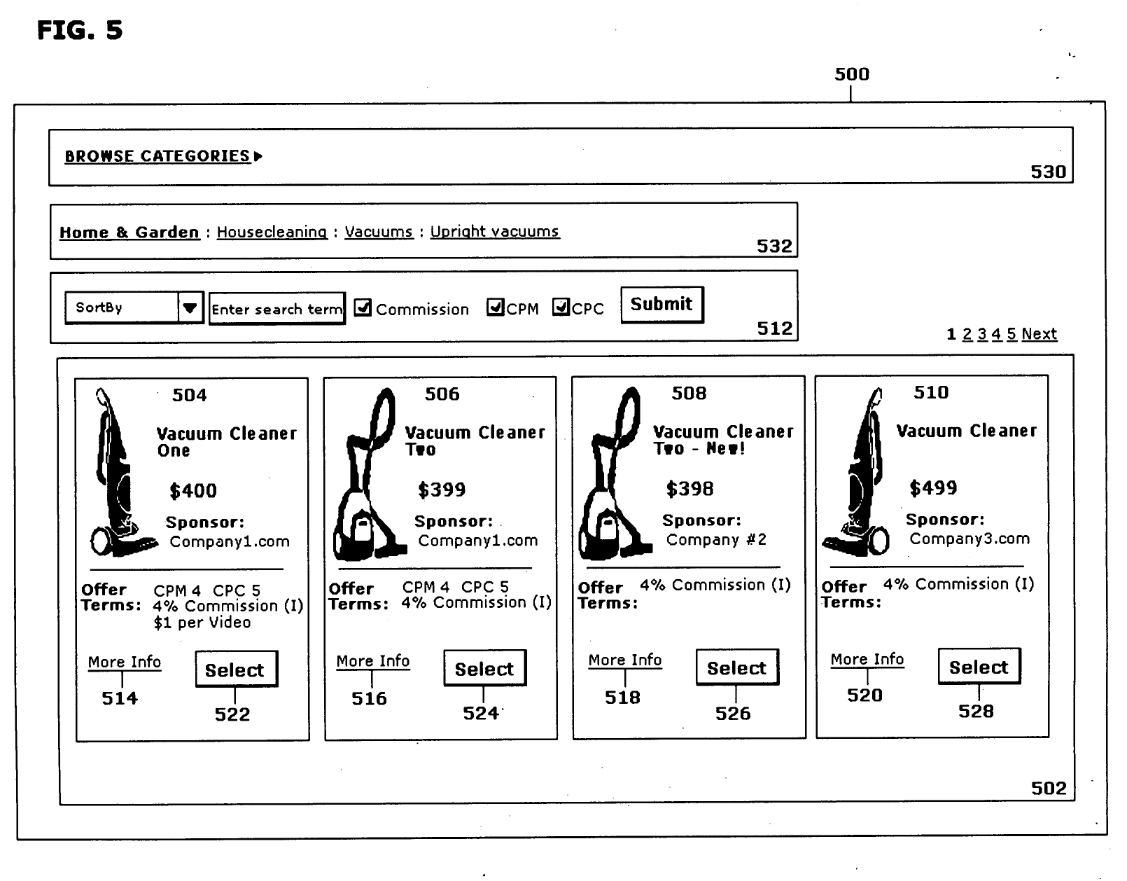

FIG. 5 presents a sample frame 500 of a display screen presented by the first viewer user interface 110 of the present disclosure. The frame 500 includes an ad section 502, ad display sections 504, 506, 508, and 510, a sort by section 512; more info options 514, 516, 518, and 520; select options 522, 524, 526, and 528; a browse categories section 530; and an optional “breadcrumb” menu section 532. The ad section 502 is for the display of the ads 122. The ad display sections 504-510 display sponsored ads which may be referred to as “offers” because an advertiser may offer compensation incentives for the use of their ads. Advertisers may be referred to as “sponsoring companies” or “sponsors”. The first viewer user interface 110 may display the frame 500 in response to the selection of the browse categories option 408 or the search option 410 in FIG. 4. The frame 500 may display a hierarchy of categories and sub-categories within the browse categories section 530 similar to the display of categories and sub-categories described above for the browse categories option 408 in FIG. 4. The frame 500 may display the optional “breadcrumb” menu 532 to indicate a category and/or sub-category associated with the ads.

A user may utilize the sort by section 512 to determine the priority for displaying the ads 122 in the frame 500 based on criteria such as the name of the advertiser associated with the ad, the name of the prod and/or service associated with the ad, the price associated with the ad, the relative popularity of the ad, or a measurement of compensation associated with the ad. For example, Maria utilizes the sort by section 512 to sort the ad display sections 504-510 from the ad display section associated with the highest commission to the ad display section associated with the lowest commission. Although the ad display sections 504, 506 508, and 510 are displayed in frame 500 in a single row, multiple rows and other layouts will suggest themselves to those of skill in the art.

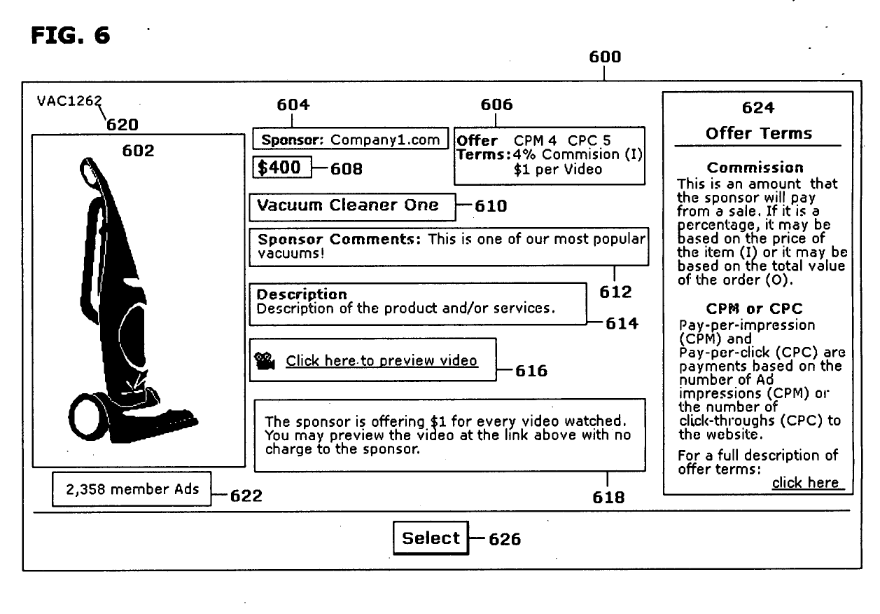

Each of the ad display sections 504-510 may contain information related to a corresponding ad, such as a small image that depicts a product and/or a service, a name of a product and/or a service, a price, an advertiser's name referred to as a “sponsor,” a logo image, and compensation incentives which may be referred to as “offer terms.” For example, the ad display section 504 depicts a small vacuum cleaner image, the product name “Vacuum Cleaner One,” the advertiser name “Company1.com,” and four offer terms, including a CPM offer, a CPC offer, a 4% commission offer, and an over for one dollar for every time a recipient of a user-ad selects to view a video file provided by an advertiser, CPM and CPC offers are described below in reference to FIG. 6. Continuing this example, a 4% commission offer informs a user that if the user selects an advertiser's ad by selecting the corresponding select option 522, the social network site 118 will associate the ad, such as the ad for “Vacuum Cleaner One,” with the user's communication, which defines the set of a user-ad, such that any recipient of the user's user-ad that selects the ad, such as the ad for “Vacuum Cleaner One,” and makes a purchase will result in the advertiser providing a percentage, such as 4%, of the purchase price to the site 118 directly and/or the user indirectly.

A user may select any of the more info options 514-520 to receive additional information about the corresponding ads before selecting any of the select options 522-528 to associate the corresponding ad with the user's communication, which defines the set of a user-ad. For example, Maria selects the more info option 514 to learn more about the corresponding vacuum cleaner ad.

FIG. 6 presents a sample frame 600 of a display screen presented by the first viewer user interface 110 of the present disclosure. The frame 600 includes an image section 602, a sponsor section 604, all offer terms section 606, a price section 608, a name section 610, a sponsor comments section 612, a description section 614, an offered link section 616, an offered link explanation section 618, an ad identifier 620, an ad popularity section 622, an offer terms explanation section 624, and a select option 626. The first viewer user interface 110 may display the frame 600 in response to the selection of the more info option 514 in FIG. 5.

The image section 602 depicts an image associated with a product and/or a service, such as an image of an upright vacuum cleaner. The sponsor section 604 may identify the name of the advertiser offering the ad, which may be an impo consideration in a user's selection of an advertisement because of the user's perception of the advertiser. The over terms section 606 may identify the compensation incentives offered by an advertiser for the site 118 directly, to a user indirectly, and/or a recipient of a user-ad directly. The displayed compensations may reflect either the totality of the offers, which then will be distributed by the site 118 as the site 118 determines to the user, or the displayed compensations may display the predetermined proportion that will go directly to the user, in which case another amount, disclosed elsewhere or not, is provided to the site 118. The price section 608 may identify the price of an associated product and/or service, such as $400 for a vacuum cleaner. The name section 610 may identify the name of a product and/or service, such as “Vacuum Cleaner One.” The sponsor comments section 612 may include additional information about a product and/or service that is too lengthy to include in the corresponding ad display sections 504-510 depicted in FIG. 5. The description section 614 may include additional information about a product and/or service that is too lengthy to include in the associated ad display sections 504-510 depicted in FIG. 5.

The offered link section 616 presents interactive-type offers provided by an advertiser. An interactive offer may include a link to a sound file, a video file, and/or other audio-visual file types provided by an advertiser An interactive offer may be stored in the ads 122, in the supplementary information 124, or located elsewhere in the system 100. After a recipient of a user-ad clicks on or selects a link to request a sound file, a video file, and/or another audio-visual file type, the advertiser may provide compensation to the site 118 directly and/or a user indirectly in an amount associated with the video link offer. For example, the vacuum cleaner ad presents an interactive offer of a link to a video provided by the advertiser. After a recipient requests to view the video, the advertiser sponsoring the ad compensates the site 118 directly and/or a user indirectly in the amount of $1 for every video which a recipient requests to view.

Alternatively or additionally, an interactive offer may include a link to a display containing a coupon offer provided by the advertiser for the use of the coupon recipient in making a purchase from the advertiser. The coupon offer is an example of compensation received by a recipient of a user-ad directly from an advertiser. An advertiser may provide compensation to the site 118 directly and/or a user indirectly for a pre-determined amount associated with the coupon offer after a user-ad recipient requests to view and/or requests to print a coupon.

Alternatively or additionally, an interactive offer may include a link to a display containing identifying information about the user who submitted the user-ad corresponding with the interactive offer. The display containing user identifying information may be referred to as a “referrer card.” A referrer card may be used by a recipient of a user-ad to give to the advertiser offering the interactive offer in return for a compensation such as a discount, a free product, and a free service provided by the advertiser. The referrer card may be given to an advertiser via an interaction through the network 108 and/or in the physical presence of a representative of the advertiser.

Alternatively or additionally to the compensation provided directly to the recipient, the advertiser may compensate the site 118 directly and/or a user indirectly upon receipt of the referrer card presented to the advertiser by the referrer-card recipient. The advertiser's compensation incentive associated with a referrer card may be described in the offer terms section 606 and/or the offered link explanation section 618.

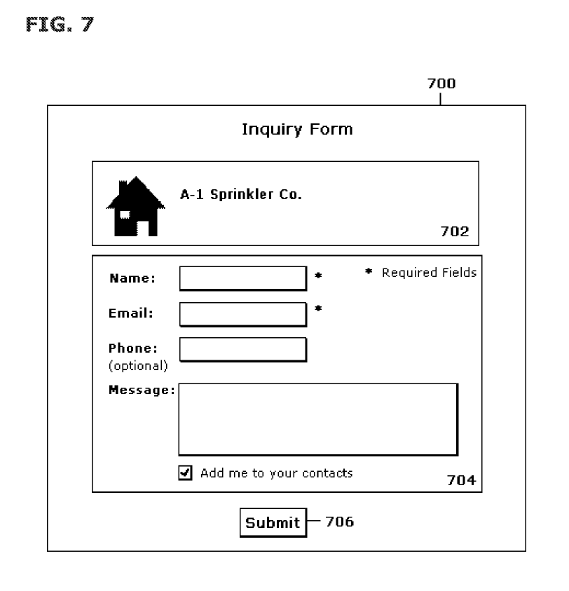

Alternatively or additionally, an interactive offer may enable a communication method used by a user-ad recipient to submit a communication via the site 118 to the advertiser offering the interactive offer. A communication method may be an online form, which is discussed in detail below in reference to FIG. 7.

An interactive offer may combine the capabilities for interactive offers. For example, a referrer card may include a coupon, an inquiry form may have a “thank you” display containing referrer information and/or a coupon. In another example, an advertiser may have an inquiry form and the “thank you” page may contain a coupon and/or a referrer card. An advertiser may pay additional compensation to the site 118 when multiple interactive offers are combined. The advertiser could pay for the online form and not be charged additionally for the coupon/and or referrer card, or the advertiser could be charged additional fees for the combination of the offers.

The offered link explanation section 618 may provide a user with additional information about the interactive offers referenced in the offer terms section 606 and/or the offered link section 616. The ad identifier 620 may be displayed in the frame 600. The ad popularity section 622 may provide a user with information pertaining to the number of times a select group of users or a total count of the users of the site 118 selected the ad to be associated with the users' communications. The offer terms explanation section 624 may include basic information on how the selection of advertisements may generate compensation and/or other revenue incentives for the site 118 directly, for a user indirectly, and/or for a user-ad recipient directly. The offer terms explanation section 624 may serve as an introduction to new users of the system 100 and as a reminder to previous users of the system 100. The offer terms explanation section 624 may be based on information that is included in the supplementary information 124. The offer terms explanation section 624 may include specific information and/or links to specific information that identify specific examples of how a user's selection from the ads 122 may generate compensation for the site 118 directly, for a user indirectly, and/or for a user-ad recipient directly, including commission examples, CPM examples, CPC examples, interactive-type offers, and any other offer defined by the advertiser.

A commission may be a compensation or payment made by an advertiser when a sale results from a user-ad. The value of the compensation or payment may be a flat fee or a percentage. If the commission is a percentage, the percentage may be based on the sale of an advertised product or service only, or the percentage may be based on a larger order that includes the advertised product or service. Commission examples may illustrate the differences between flat fees, a percentage based on an advertised product or service only, and a percentage based on a larger order that includes the advertised product or service. For example, a flat fee commission example may specify a $15 payment for a sale of a vacuum cleaner; an individualized percentage commission example may specify 4% of a $400 vacuum cleaner sale would result in a $16 payment, and an order percentage commission example may specify that 4% of a $500 order that includes the $400 vacuum cleaner sale would result in a $20 payment.

CPM stands for Cost Per iMpression, which specifies the cost to an advertiser each time a recipient of a user-ad requests to view the advertiser's sponsored ad of the user-ad, and may be expressed in dollars per thousand impressions. From the perspective of a user who may request to select a sponsored ad for the user's user-ad, CPM stands for pay per impression, which is the amount of compensation an advertiser may compensate the site 118 directly and/or the user indirectly each time a recipient of the user's user-ad requests to view the advertiser's ad. For example, the advertiser offering the vacuum cleaner advertisement may compensate the site 118 directly with $4 for every thousand times recipients of her user-ad request to view the user-selected sponsored ad of her user-ad.

CPC stands for Cost Per Click, which specifies the cost to an advertiser each time a recipient of a user-ad clicks or selects the user-selected sponsored ad of the user-ad, and may be expressed in dollars per hundred clicks or selections. From the perspective of users who may request to select a sponsored ad for the user's user-ad, CPC stands for pay per click or selection, which is the amount of compensation an advertiser may compensate the site 118 directly and/or the user indirectly each time a recipient of the user's user-ad clicks or selects the user-selected sponsored ad. For example, the advertiser offering the vacuum cleaner ad may compensate the site 118 with $5 for every hundred times that recipients of Maria's user-ad click or select the sponsored ad she selected for her user-ad.

FIG. 7 presents a sample frame 700 of a display screen presented by the second viewer user interface 112 of the present disclosure. The frame 700 includes an advertiser info section 702, a communication section 704, and a submit option 706. The advertiser info section 702 contains information about an advertiser, such as the name of the advertiser, a logo image, a description of the products and/or services provided by the advertiser, instructions about the communication section 704, and information about the advertiser's offers. The communication section 704 enables a communication method, such as via an online form, which enables a user-ad recipient to send a communication to the advertiser associated with the sponsored ad. A communication entered in the communication section 704 may be sent in response to the selection of the submit option 706 by a user-ad recipient. An advertiser may provide compensation to the site 118 directly, a user indirectly, and/or a user-ad recipient after each time a recipient of the user-ad requests to initiate a communication and/or requests to submit a communication to the advertiser. If an online form is used as the communication method in the communication section 704, the site 118 may provide an advertiser with a predefined form of input fields and/or the option to select the input field names, the number of fields, and the field types. An advertiser may provide additional compensation to the site 118 to customize online forms and/or other communication methods associated with an interactive offer of the advertiser's ad.

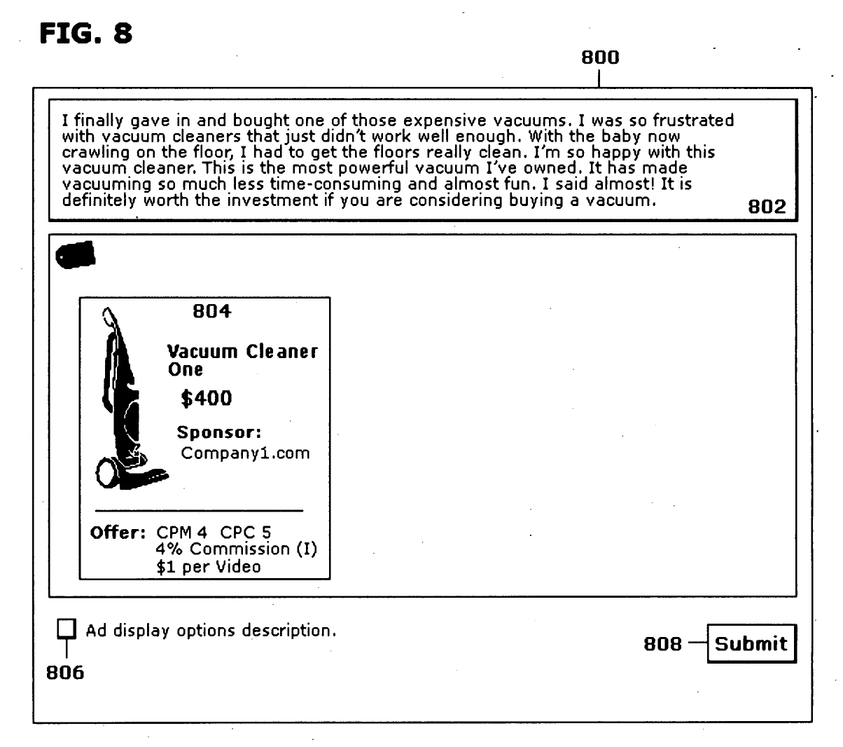

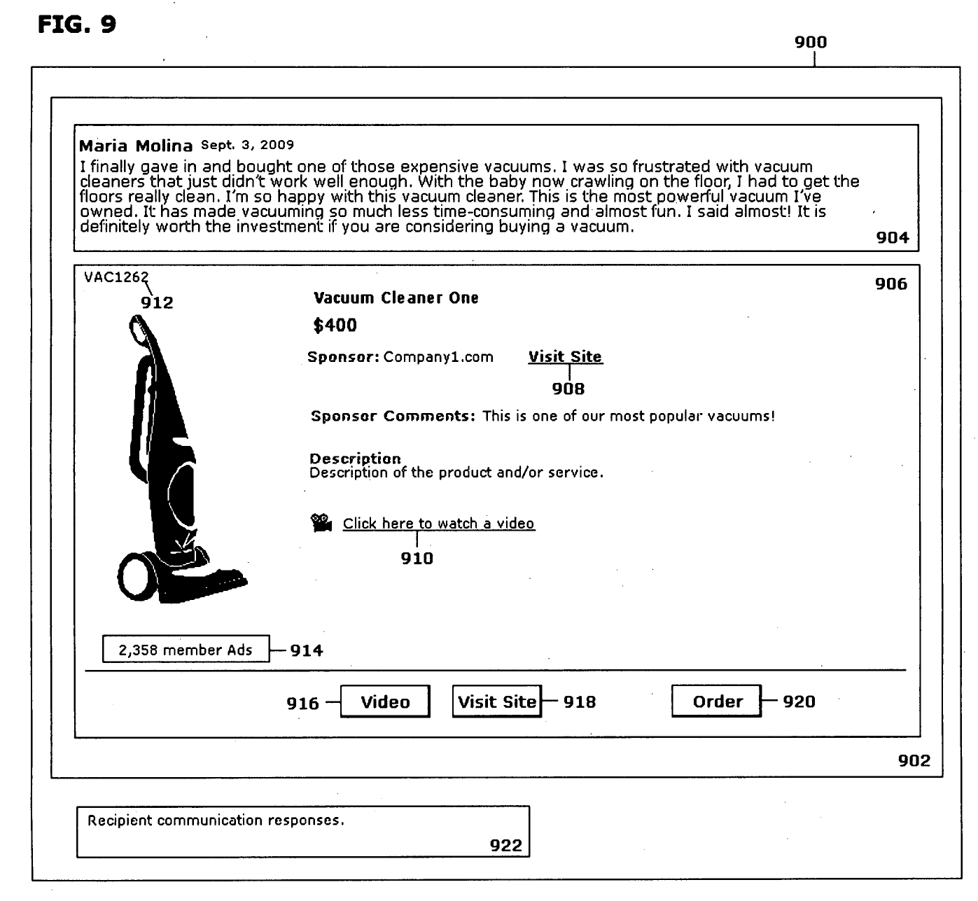

FIG. 8 presents a sample frame 800 of a display screen presented by the first viewer user interface 110 of the present disclosure. The frame 800 includes a communication section 802, an ad section 804, an ad display option 806, and a submit option 808. The first viewer user interface 110 may display the frame 800 as a preview of a user-ad, the set consisting of a user communication and a user-selected ad in response to the selection of the select option 626 in FIG. 6.

A user may enter a communication in the communication section 802 after selecting the select option 626 in FIG. 6, or the communication section 802 may include the communication the user previously entered in the communication section 202 in FIG. 2, the communication section 302 in FIG. 3, or the communication section 402 in FIG. 4. Although the communication sections 202, 302, 402, and 802 may include text communication, a user may submit audio files, video files, and/or other audio-visual file types via the communication sections 202, 302, 402, and/or 802. The ad section 804 depicts a user-selected ad, which may include an image associated with a product and/or a service, such as an image of an upright vacuum cleaner.

The ad display option 806 may provide a user with the option of automatically displaying a user-selected ad in full or in part with a user's communication, or requiring a recipient of a user-ad to select to view the user-selected ad with or without the user's communication. Details of displaying a user-ad to a recipient are described below in reference to FIG. 9. If a user selects the ad display option 806, the percentage of user-ad recipients who may become engaged in viewing an automatically displayed user-selected sponsored ad of the user-ad may actually decrease because some of the recipients may ignore the displayed ad. If a user does not select the ad display option 806, the percentage of user-ad recipients who may become engaged in viewing a user-selected sponsored ad that must be requested by the recipient may actually increase because recipients who take an active step to request to view the user-selected sponsored ad may be much more interested in the user-selected sponsored ad. A user-ad recipient who requested to view a user-selected sponsored ad may be more valuable to the advertiser sponsoring the user-selected ad than a user-ad recipient who did not request to view the user-selected sponsored ad A user-ad recipient who has selected to view a user-selected sponsored ad may be in a more receptive state of mind to receive the ad information and may be more likely to become a customer of the sponsoring advertiser because the recipient has already taken an action to request the sponsored ad. Therefore, advertisers may offer higher rates for GPM offers when the ad display option 806 is not selected than when the ad display option 806 is selected. Alternatively or additionally, an advertiser may provide a CPM offer that is dependent on whether the display option 806 is selected or not selected.

When a user is satisfied with the appearance and/or the content of the user's communication in the communication section 802 and/or the user-selected ad in the ad section 804, and decided whether or not to select the ad display option 806, the user may select the submit option 808 to request the site 118 to associate the user-selected ad with the user's communication, thereby generating the set of a user-ad.

In response, the site 118 associates the user's communication with the user-selected ad, such as the vacuum cleaner ad, thereby generating a set of the user-ad. Each ad may have a unique uniform resource locator address that enables the tracking of the ad impressions, clicking the ad, selecting the ad, and making a purchase through the ad. In contrast to data mining techniques, which may expend significant resources to accumulate large amounts of data in an attempt to predict which users may have a high likelihood of responding to an advertisement, a user of the site 118 may select user-ad recipients based on personal knowledge of which potential recipients may be most likely to appreciate and respond to the user's user-ad. Alternatively, a potential recipient may seek out a user's user-ad, such as a user-ad posted on a web page within the site 118, based on personal knowledge of the user and/or no prior knowledge of the user of the site 118.

FIG. 9 presents a sample frame 900 of a display screen presented by the second view user interface 112 of the present disclosure. The frame 900 includes a user-ad section 902, a user-ad communication section 904, a user-ad ad section 906, a visit site option 908, an offered link option 910, an ad identifier 912, an ad popularity section 914, a second offered link option 916, a second visit site option 918, an order option 920, and a user-ad discussion section 922. The second viewer user interface 112 may display the frame 900 in response to a communication recipient's request to view a user-ad. The user-ad section 902 is for the display of a user-ad, consisting of a user's communication in the user-ad communication section 904 and a user-selected ad in the user-ad ad section 906. The user-ad ad section 906 may contain a small image that depicts a product and/or a service, a name of a product and/or a service, a price, an advertiser's name and/or logo image, advertiser's comments, a description of the product and/or service, a visit site option 908, an offered link option 910, an ad identifier 912, an ad popularity section 914, a second offered link option 916, a second visit site option 918, and an order option 920.

When a recipient of a user-ad clicks or selects the visit site option 908, the second viewer user interface 112 may display a web page associated with the corresponding ad via the network 108, After a user-ad recipient clicks or selects the visit site option 908, an advertiser sponsoring the corresponding ad may compensate the site 118 directly and/or a user indirectly if the advertiser offers a CPC offer associated with the user-selected ad in an amount pre-defined by the CPC offer. If the visit site option 908 does not have an associated advertiser, such as when a user enters the information for an ad, the site 118 will not receive compensation from an advertiser after a user-ad recipient clicks or selects the visit site option 908. If the advertiser sponsoring the user-selected ad corresponding to the visit site option 908 does not offer a CPC offer for the user-selected ad, the site 118 may not receive compensation from an advertiser after a user-selected recipient clicks or selects the visit site option 908. The second visit site option 918 provides a user-ad recipient with another opportunity to visit the web site of the advertiser sponsoring the user-selected ad of the user-ad in a similar process as for the visit site option 908. The second visit site option 918 is presented at a standard location for all ads so the user does not need to read through the ad description to find the option.

When a user-ad recipient clicks or selects the offered link option 910, the second viewer user interface 112 may enable the activation of a video file, sound file, and/or other audio-visual file type provided by the advertiser sponsoring the user-selected ad of the user-ad. After a user-ad recipient clicks or selects the offered link option 910, the advertiser sponsoring the corresponding ad may compensate the site 118 directly and/or a user indirectly if the advertiser provides an offer associated with a requested file in an amount pre-defined by the offer. The second offered link option 916 provides a user-ad recipient with another opportunity to request a file provided by the advertiser sponsoring the user selected ad of the user-ad in a similar process as for the offered link option 910. The offered link option 916 is presented at a standard location for all ads so the user does not need to read through the ad description to find the option.

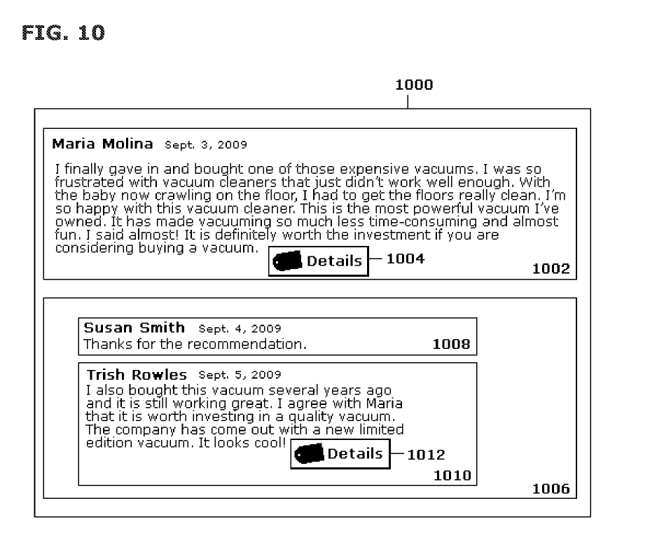

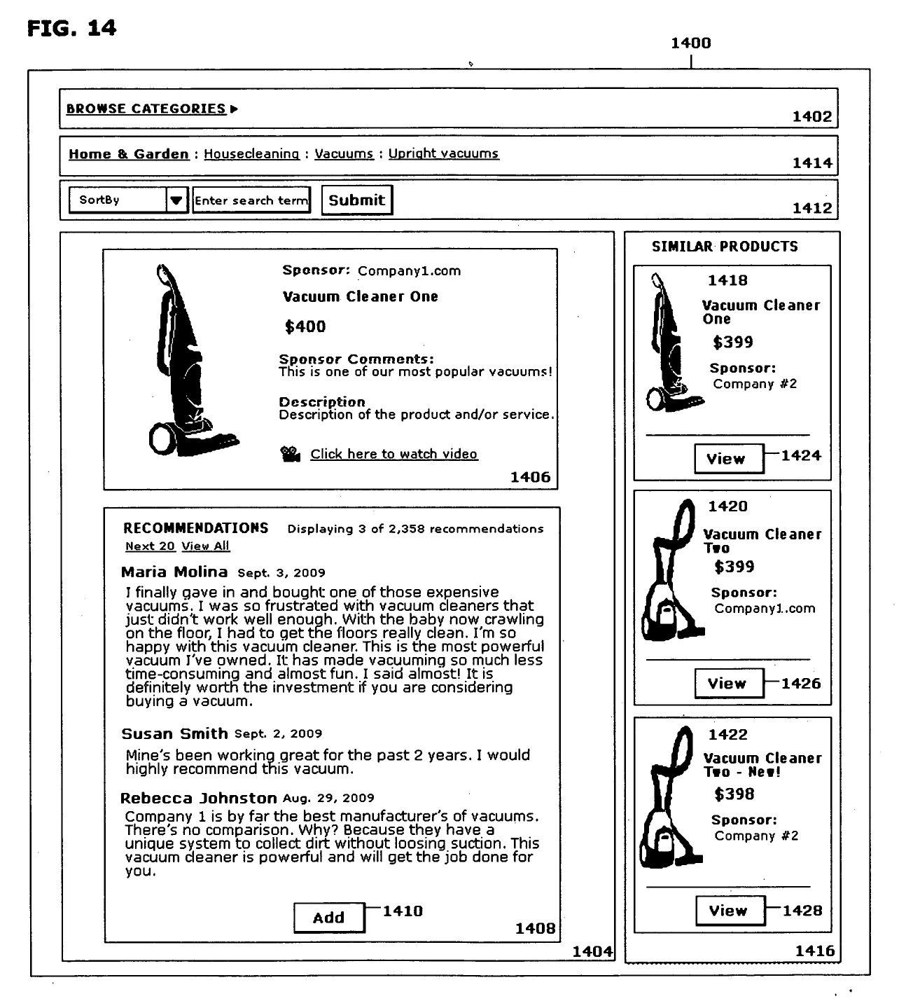

The site 118 may provide users of the site 118 with the ability to order a product and/or a service directly from a user-ad or a site-ad via an order processing system within the site 118. A site-ad is described in detail in reference to FIG. 14. A user may purchase a product and/or a service directly from a user-ad within the site 118 by clicking on or selecting the order option 920. The site 118 may forward the order information received from a user to the advertiser sponsoring the ad associated with the purchased product and/or service for payment collection and final order processing steps, such as shipping a product in the mail or activating a subscription. Alternatively, the site 118 may receive an order with a payment and subsequently forward the order information and payment to the advertiser sponsoring the user-selected ad of the user-ad with the order for final order processing steps. If the site 118 receives payments with the orders, the site 118 may deduct an amount received from an order from any compensation due from the advertiser to the site 118. An advertiser may provide additional compensation to the social network site 118 to process orders and/or collect payment from the purchasing users. The user-ad discussion section 922 is related to recipient communication responses, which are discussed in detail below in reference to FIG. 10.

FIG. 10 presents a sample frame 1000 of a display screen presented by the second viewer user interface 112 of the present disclosure. The frame 1000 includes a user-ad section 1002, a user-ad details option 1004, a user-ad discussion section 1006, a first recipient response section 1008, a second recipient response section 1010, and a recipient user-ad details option 1012. The second viewer user interface 112 may display the frame 1000 in response to a request to view a user-ad. The user-ad section 1002 displays a user-ad consisting of a user's communication and a user-ad details option 1004 that is associated with a user-selected ad.

If a user-ad recipient of the frame 1000 finds the user-ad in the user-ad section 1002 to be interesting, the user-ad details option 1004 provides the user-ad recipient with the option to select an alternate display of the user-ad consisting of the set of a user's communication and a user-selected ad in a format similar to frame 900 in FIG. 9. The recipient discussion section 1006 enables communications provided by user-ad recipients. The first recipient response section 1008 depicts a communication response from a first communication recipient to respond to a user-ad, and the second recipient response section 1010 depicts a communication response from a second communication recipient to respond to the user-ad. The recipient user-ad details option 1012 indicates that the second communication recipient, a user named Trish, followed a similar process to the process followed by Maria, who submitted her user-ad. Trish submitted a user-ad displayed in the second recipient response section 1010. If a user-ad recipient of the frame 1000 finds a user-ad in the second recipient response section 1010 to be interesting, the recipient user-ad details option 1012 provides the user-ad recipient with the option to display the user-ad associated with the second recipient response in a format similar to the frame 900 in FIG. 9. When a user-ad recipient requests to view a user-ad, clicks or selects the user-ad, and/or makes a purchase via the user-ad, the advertiser sponsoring the user-selected ad of the user-ad may provide similar compensation to the site 118 directly and/or the user who submitted the user-ad indirectly, such as the user Trish in the above example.

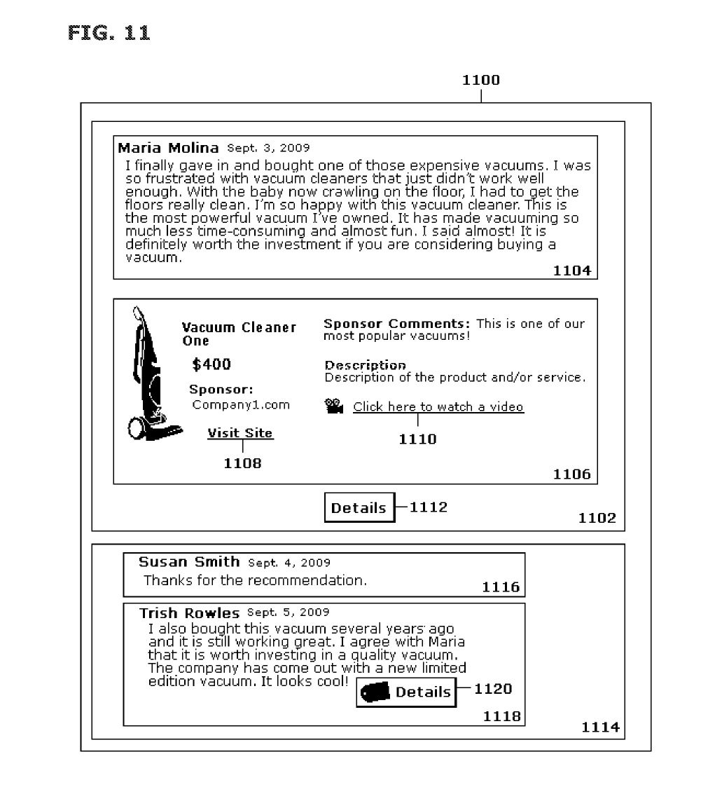

FIG. 11 presents a sample frame 1100 of a display screen presented by the second viewer user interface 112 of the present disclosure. The frame 1100 includes a user-ad section 1102, a user-ad communication section 1104, a user-ad ad section 1106, a visit site option 1108, an offered link option 1110, a user-ad details option 1112, a user-ad discussion section 1114, a first recipient response section 1116, a second recipient response section 1118, and a recipient user-ad details option 1120. The second viewer user interface 112 may display the frame 1100 in response to a request to view a user-ad. The elements 1102, 1114, 1116, 1118, and 1120 are similar to the elements 1002, 1006, 1008, 1008, 1010, and 1012 described above in reference to FIG. 10 with the following exception: the user-ad section 1102 displays a user's communication in the user-ad communication section 1104 and a user's selected ad in the user-ad ad section 1106 that may contain information such as a small image that depicts a product and/or a service, a name of a product and/or a service, a price, a sponsor's name, a logo image, sponsor comments, a description of the product and/or service that may be a shorter version of the description displayed in the user-ad ad section 906 in FIG. 9, a visit site option 1108 with a similar function as the visit site option 910 FIG. 9, and an offered link option 1110 with a similar function as the offered link option 910 in 9.

After a user-ad recipient requests to view the user-ad, clicks or selects the user-ad, and/or makes a purchase via the user-ad, the advertiser sponsoring the user-selected sponsored ad of the user-ad may provide compensation to the site 118 directly, the user indirectly, and/or the user-ad recipient of the user-ad directly. The site 118 may forward a portion of the compensation to the user who selected the sponsored ad, such as the vacuum cleaner ad, to be part of the user's user-ad, such as the user-ad for the vacuum cleaner. For example, the advertiser of the vacuum cleaner ad pays $16 (4% of the $400 vacuum cleaner sales price) to the site 118 and the site 118 pays $8 (2% of the $400 vacuum cleaner sales price) to Maria because she selected the vacuum cleaner ad to be part of her user-ad about the vacuum cleaner. Although this example depicts the site 118 providing half ($8 of $16) of the compensation received from the advertiser to a user who selected the advertiser's ad, embodiments of the present disclosure may use any other ratio of distributing the compensation from the advertiser between the site 118 and the user. Although this example refers to a percentage commission displayed in the offer terms section 606 of the frame 600 displayed to a user, alternative approaches may not disclose the advertiser's entire offer, such as the part given to the site 118, to the user. For example, the site 118 may decide what the distribution ratios may be or the site 118 may negotiate such distribution ratios with advertisers in advance, thereby enabling the advertisers to specify a specific pre-determined compensation to be received by a user from the site 118 as an incentive to select the advertiser's ad to be part of the user's user-ads. Additionally or alternatively, the site 118 may provide other forms of compensation to a user, such as a credit associated with a potential purchase, a reduction in expenses associated with the site 118, an amount of uncharged services associated with the site 118, and a charity donation to a charity selected by the site 118 or selected by the user. For example, the site 118 may provide Maria with a credit of $8 that she may use to make purchases of products and/or services offered for sale via the site 118.

FIG. 12 presents a sample frame 1200 of a display screen presented by the second viewer user interface 112 of the present disclosure. The frame 1200 includes a user-ad section 1202, user-ad display sections 1204, 1206, 1208 and 1210, selected ad sections 1212, 1214, 1216, and 1218, user communication sections 1220, 1222, 1224, and 1226, visit site options 1228, 1230, 1232, and 1234, user-ad details options 1236, 1238, 1240, and 1242, a categories section 1244, and a sortby section 1246. The second viewer user interface 112 may display the frame 1200 in response to a request from a communication recipient to review a user's compilation or list of the user's user-ads. For example, a user named Susan is happy that she followed Maria's vacuum cleaner recommendation and purchased the vacuum cleaner through Maria's user-ad, and wants to know what other recommendations Maria has previously made. The user-ad section 1202 displays a user's compilation or list of the user's user-ads. Each of the user-ad display sections 1204-1210 may represent a user-ad, which consists of a set of a user's communication and a user-selected ad. Each of the selected ad sections 1212-1218 may display a user-selected ad. Each of the user communication sections 1220-1226 may display a user's communication.

When a recipient of a user-ad list clicks or selects the visit site option 1228, the second viewer user interface 112 may display a web page associated with a corresponding selected ad section 1212 via the network 108. After a recipient of a user-ad list clicks on or selects the visit site option 1228, the advertiser sponsoring the corresponding selected ad section 1212 may compensate the site 1118 directly and/or the user indirectly if the advertiser offers a CPC over associated with the user-selected ad in an amount pre-defined by the CPC offer terms. If the visit site option 1228 does not have an associated advertiser, the site 118 may not receive compensation from an advertiser after a recipient of a user-ad list clicks on or selects the visit site option 1228. For example, if Maria decided to recommend a business named Joe's Sprinkler Company in her user-ad, and she entered a website address for Joe's Sprinkler Company in the enter a lead section 314 of frame 300 in FIG. 3, the visit site option 1232 associated with her user-ad would not result in a compensation for the site 118 when a viewer clicks on the visit site option 1232. If an advertiser sponsoring an ad associated with the visit site option 1228 does not offer a CPC offer for the ad, the site 118 may not receive compensation from an advertiser after a recipient of a user-ad list clicks on or selects the visit site option 1228.

If an advertiser does not provide a website or a user entered ad information without a website in the enter a lead section 314 in FIG. 3, the visit site options 1228, 1230, 1232, and 1234 would not be displayed. When a recipient of a user-ad list selects the user-ad details option 1236, the second viewer user interface 112 may respond by displaying the user-ad associated with the user-ad details option 1236 in a format similar to the frame 900 in FIG. 9.

The compilation or list of user-ads 1204, 1206, 1208, and 1210 may be assigned into a category named by a user. Naming categories and assigning compilations or lists of user-ads to these categories may enable user-ad list recipients to review the user-ads in an organized presentation. The categories section 1244 may display a hierarchy of categories and sub-categories selections within, similar to the display of categories and sub-categories described for the browse categories section 408 in FIG. 4 and the browse categories section 530 in FIG. 5. For example, the categories section 1244 includes Maria's categories for “my favorite things,” “best bargains,” “for baby,” “hints for hubby,” “for the home,” “Emily's wish list,” “products for causes,” and “David's Christmas list to Santa.” The user-ads represented by the display sections 1204, 1206, 1208, and 1210 may be assigned into the “my favorite things” category by the user, such that a user-ad list recipient may select this category to review a display that includes the assigned user-ads, the category name of the user-ad list, a description of the user-ad list entered by the user, and any user-ad list recipient communication responses to the user-ad list. For example, if Susan followed Maria's recommendation to purchase the vacuum cleaner and is interested in additional household recommendations that Maria has made. Susan may select the “for the home” category from Maria's categories section 1244. The second viewer user interface 112 may respond to Susan's selection of the “for the home” category from Maria's categories section 1244 by displaying a different user-ad list, including a different category name and/or description, different assigned user-ads, and different user-ad list recipient communication responses to this user-ad list. A user may elect to communicate the user's user-ad list from their categories section 1244 with another user or other users of the social network site 118 when the user assigns user-ads to a category or when the user re-assigns user-ads to the category.

A user-ad list may be sponsored so that it becomes similar to one of the advertisements 122. For example, a business that sells products may sponsor a user-ad list named “10 best sellers” which consists of 10 assigned user-ads that individually contain a sponsored ad by the business. The business may encourage their customers and/or other users of the site 118 to select the sponsored user-ad list for use in a user-ad which may result in the promotion of the business' products. The advertiser may select to use a user-ad list set-up by the advertiser or the advertiser may select to use a user-ad list set-up by a user. If the advertiser selects to use a user-ad list set-up by a user, the advertiser may provide a compensation incentive directly to the user who set-up the user-ad list in a user-ad in addition to any offer terms associated with the sponsored user-ad list as an ad. Alternatively, a user may select a user-ad list via the internal page section 316 or the select your ad list section 318 in FIG. 3, which represents the use of a user-ad list as part of a user-ad that is not sponsored and does not generate a compensation to the site 118 directly or a user indirectly.

A user may manage the order in which the user-ad lists are displayed in the categories section 1244 and manage the order in which each user-ad is displayed within each user-ad list. A user may also add any user-ad to any user-ad list, edit any user-ad from any user-ad list, and/or delete any user-ad from any user-ad list. A user may edit a category name and/or a description of the category. A user may edit a user-ad by changing the user's communication and/or the user's selected-ad without deleting the original user-ad.

In addition to selecting from a user's categories, a user-ad list recipient may use the sort by section 1246 to determine the priority for displaying the user-ads in the frame 1200 based on criteria such as whether the user-ads are for products or services, product or service names, advertiser names, and/or the date generated. This is helpful if a user has a large number of user-ads and a user-ad recipient wants to see if the user has made a recent recommendation for a particular product or service. Although the user-ad display sections 1204-1210 are displayed in frame 1200 in a single row, multiple rows and other layouts will suggest themselves to those of skill in the art.

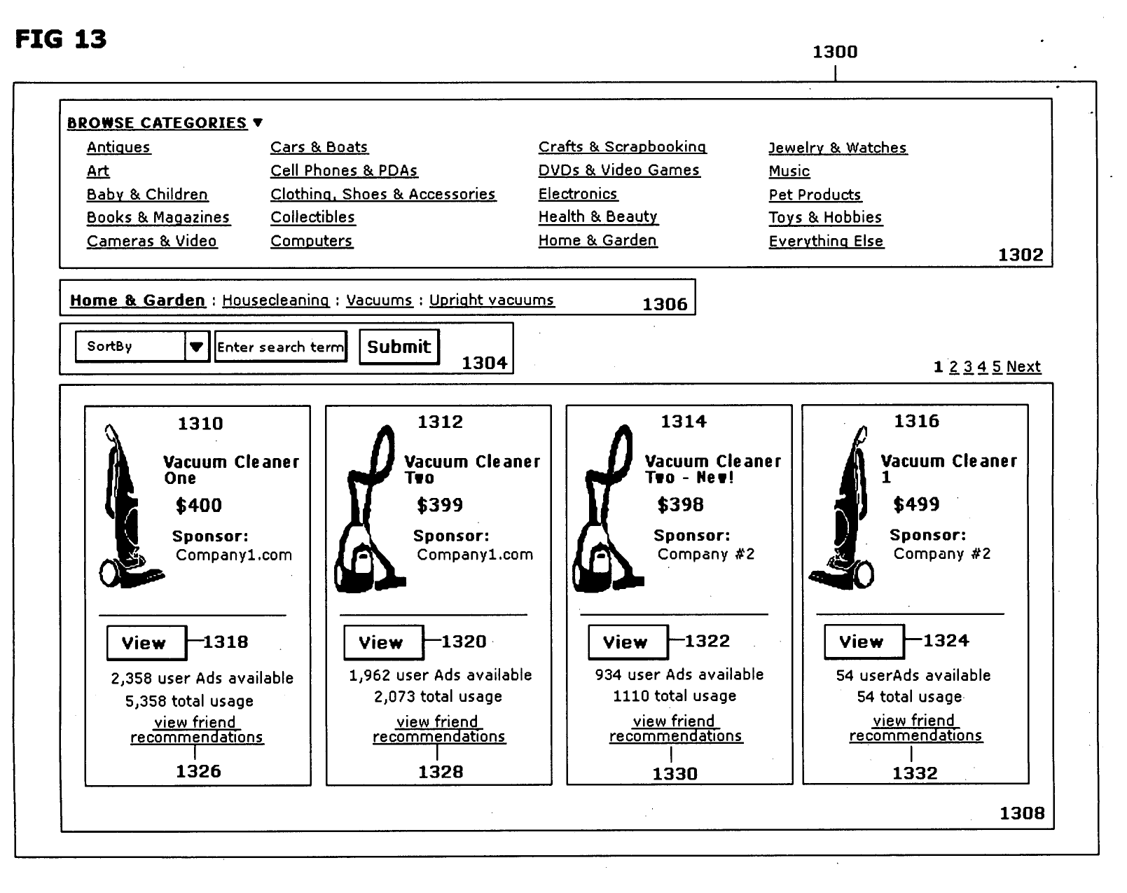

FIG. 13 presents a sample frame 1300 of a display screen presented by the second viewer user interface 112 of the present disclosure. The frame 1300 depicts a virtual “ad mall,” and includes a browse categories section 1302, a sortby section 1304, a “breadcrumb” menu section 1306, an ads section 1308, ad display sections 1310, 1312, 1314, 1316, view ad options 1318, 1320, 1322, and 1324, and view recommendation options 1326, 1328, 1330, and 1332. The second viewer user interface 112 may display the frame 1300 in response to a request from a user to review a compilation or list of the advertisements 122. For example, Susan wants to compare the popularity of the vacuum cleaner recommended by Maria with the popularity of other vacuum cleaners recommended by other users of the site 118. The categories section 1302 may display a hierarchy of categories and sub-categories similar to the display of categories and sub-categories that resulted from a selection of the browse categories option 408 in FIG. 4 and similar to the display of categories and sub-categories described for the browse categories section 530 in FIG. 5. Continuing the example. Susan may use the categories section 1302 to specify that she wants to view vacuum cleaner ads recommended by other users of the site 118. Susan may also specify whether she wants the site 118 to total the vacuum cleaner recommendations for Susan's own social network contacts, which may include hundreds of her friends, or for all users of the site 118, which may include millions of people that Susan does not know. Similar to the options provided by the sortby section 512 in FIG. 5, a user may use the sortby section 1304 to determine the priority for displaying the ads 122 in the frame 1300 based on criteria such as the name of the advertisers associated with the ads, the name of the products and/or services associated with the ads, the price associated with the ads, and the relative popularity of the ads. The “breadcrumb” menu section 1306 may display the category and/or sub-category associated with the ads. The ad section 1308 displays some of the ads 122. Each of the ad display sections 1310, 1312, 1314, and 1316 may specify the total number of times that users of the social network site 118 have associated a communication with the corresponding ad and/or the number of user-ads that are currently available for a user to review within the site 118, thereby providing a relative indication of the popularity for the associated product and/or service. For example, Susan sees that the display order for the ad display sections 1310-1316, which is in descending order of the number of user-ads displayed to her, indicates that the vacuum cleaner ad that Maria associated with her recommendation is the most recommended vacuum cleaner ad, and that the ad 1310 has been recommended 5,358 times within the site 118.

A user may select the view ad option 1318 to review additional information about the corresponding ad and users' communication responses about the ad, which may include communications from user-ads and/or communications added by users within the ad mall. A user may select the view recommendation option 1326 to review additional information about the corresponding ad and communication responses about the ad provided by a group of user-defined contacts within the social network site 118.

FIG. 14 presents a sample frame 1400 of a display screen presented by the second viewer user interface 112 of the present disclosure. The frame 1400 includes a browse category section 1402, a site-ad section 1404, a sponsored ad sec on 1406, a recommendations section 1408, an add recommendation option 1410, a sort by section 1412 a “breadcrumb” menu 1414, a coordinating site-ads section 1416, site-ad display sections 1418, 1420, and 1422, and view site-ad options 1424, 1426, and 1428. The second viewer user interface 112 may display the frame 1400 in response to a selection of any of the view ad options 1318-1324 in FIG. 13. The frame 1400 may display a hierarchy of categories and sub-categories within the browse categories section 1402, similar to the display of categories and sub-categories for the browse categories section 1302 in FIG. 13. The site-ad section 1404 includes the sponsored-ad section 1406 and the recommendations section 1408. The sponsored ad section 1406 displays information associated with an ad sponsored by an advertiser. The recommendations section 1408 displays the communication responses by users of the site 118 which correspond to the sponsored ad and the add recommendation option 1410, which enables a user to enter a communication to be associated with the sponsored ad, and/or the communication responses by users of the site 118 which correspond to the sponsored ad.

A set consisting of an ad and a display of multiple users recommendation communications may be referred to as a “site-ad.” A site-ad represents an advertisement that is different from the original ad and may be distinguished from the original ad by an addition of a display of multiple users' communication and/or an addition of the add recommendation option 1410.

A user may use the sortby section 1412 in a process similar to that described for the sortby section 1304 in FIG. 13. The frame 1400 may display the “breadcrumb” menu section 1414 to indicate a category and/or sub-category associated with the site-ad, similar to the “breadcrumb” menu section 1306 in FIG. 13. The coordinating site-ads section 1416 may include the site-ad display sections 1418-1420 that each represent a site-ad and may display an image of a product and/or service, a name of a product and/or service, an advertiser's name, and/or a price associated with the site-ad. When a user clicks or selects the view site-ad option 1424, the user requests the corresponding site-ad to be displayed within the site-ad section 1404.

Alternatively or additionally, the social network site 118 may provide an “ad directory” that is similar to the “ad mall” presented in frame 1300 in FIG. 13 and frame 1400 in MG, 14 with the following exception: the browse categories section 1402 may prominently display an option for a user to determine the priority for the display of the site-ads by geographical location. For example, Maria may want to know what hotel recommendations other users of the site 118 have made for hotels in Hawaii where she is planning to visit. When a user requests a display of the “ad directory”, the second viewer user interface 112 of the present disclosure may automatically select to initially display site-ads to the user based on a user-defined geographic location. In the example of Maria, when she visits the “ad directory”, she is presented with site-ads for services available in her hometown city, which she previously identified to the site 118, and may subsequently change the geographical location selection.

When a user visits the virtual “ad mall” and/or the virtual “ad directory” and views a site-ad, selects a site-ad, and/or makes a purchase through a site-ad, the advertiser sponsoring the ad associated with the site-ad may provide compensation to the site 118. However, the site 118 may not provide a portion of this compensation to any users of the site 118 because the site-ads may be attributed to selections by thousands of users, not any specific user to whom the site 118 may provide compensation. Therefore, if Trish visits the “ad mall” and purchases the vacuum cleaner that Maria recommended through a site-ad provided by the virtual “ad mall,” the sponsoring company pays $16 to the site 118, but the site 118 does not distribute any portion of the compensation among the 2,358 users who recommended the vacuum cleaner, such as Maria.

An advertiser may sponsor a web page provided by the social network site 118 to promote their business and to encourage users of the site 118 to select the ads sponsored by the advertiser to be associated with the users' communications. An advertiser may sponsor a web page associated with the “ad mall” containing discussions and/or other user communications about products and/or services related to the advertiser's business. For example, a clothing store may sponsor a web page with an online discussion among the users of the site 118 with the topic of discussion being “What's your favorite brand of jeans?” Continuing the example, promotional information related to the advertiser may be displayed prominently on the web page, such as the name of the advertiser, a logo provided by the advertiser, links to the advertiser's web page, links to the advertiser's web pages within the social network site, and displays of the advertiser's sponsored ads. An advertiser may provide additional compensation to the social network site 118 for the sponsorship of web pages.

The site 118 may provide the advertiser and/or the users with data and/or reports about the usage of the ads 122. For example, the site 118 may provide the advertiser with compiled data such as the number of users currently using the advertiser-provided ads in a user-ad, the number of impressions of an ad, the number of click-throughs of an ad, the number of interactions by a recipient of an ad, and the sales generated from an ad. For example, the site 118 may provide the user with compiled data based on the user's user-ads such as the number of user-ads, the number of impressions of a user-ad, the number of click-throughs of a user-ad, the number of interactions by a recipient of a user-ad, the number of interactions by a recipient of a user-ad, and the sales generated from a user-ad. Such data reporting may also allow the advertiser and/or user to select display options for the data such as selecting a time range.

Users and communication recipients may repeat the processes described above as desired. Embodiments of the present disclosure provide interactive advertising that is consistent with the intended use of social network sites because users utilize such sites to enhance their interactions with other site users.

Because the frames 200-1400 are examples, the frames 200-1400 could vary greatly in appearance. For example, the relative sizes and positioning of the elements in each frame are not important to the practice of the present disclosure. The frames 200-1400 can be depicted by any visual display, but are preferably depicted by a computer screen. The frames 200-1400 may be part of a personal computer system and/or a network, and operated from data received locally, by the network, and/or on the Internet. The frames 200-1400 may be navigable by a user. Typically, the user can employ a mouse input device to point-and-click to a location on the frames 200-1400 to manage the information depicted by the frames 200-1400, such as the selection of ads. Alternately, the user can employ directional indicators, or other input devices such as a keyboard. The information depicted by the frames 200-1400 are examples, as the frames 200-1400 may have a much larger number of sections, fields, and/or options. Note that although some elements as shown are located iii some parts of the frames 200-1400, in another embodiment the elements could be located in other parts of the frames 200-11400. The frames 200-1400 also include fields in which the user can input information, such as the names of products. The frames 200-1400 may be part of a larger display screen that includes fields for users to enter search criteria, such as searches based on categories. The user interfaces 110-116 may output a display screen that includes the frames 200-1400 in response to a search based on search criteria input via the viewer user interfaces 110-116. For example, a viewer may enter the name of a product, and the user's interface may output a display screen that depicts an ad for the product.

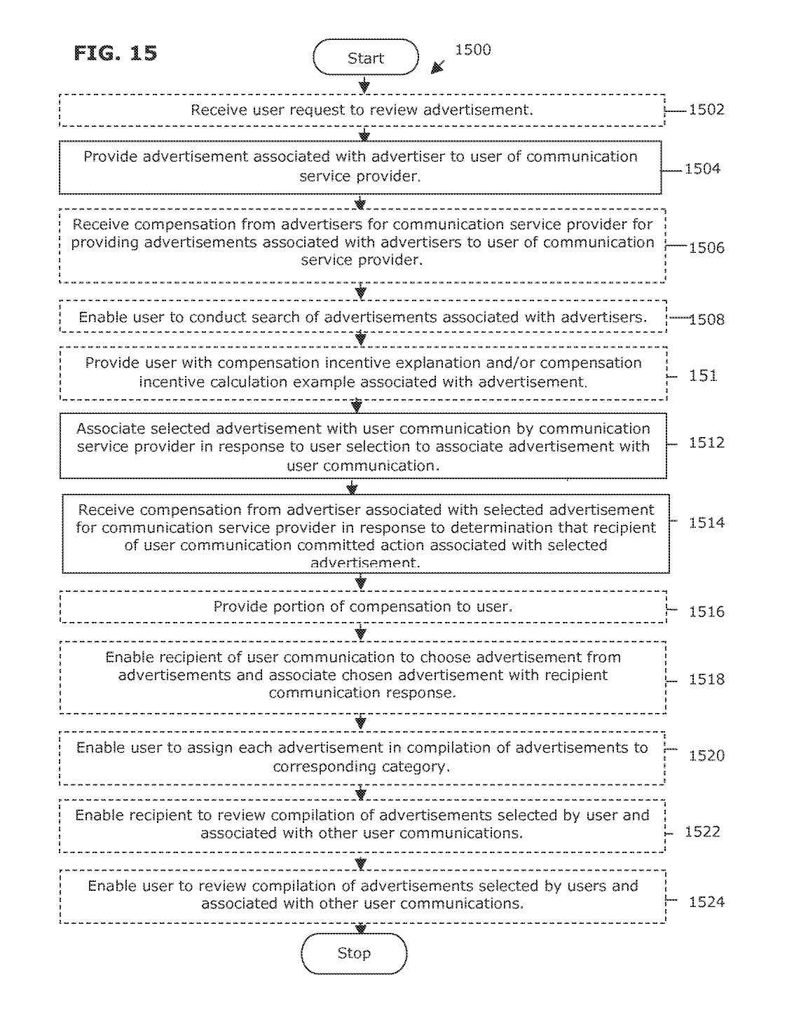

FIG. 15 presents a sample method 1500 of the present disclosure. The system 100 may execute the method 1500 to provide interactive advertising for computer mediated communications.

In box 1502, a user request to review an advertisement is optionally received. For example, the site 118 receives Maria's request to review the ads 122.

In box 1504, all advertisement associated with an advertiser is provided by a communication service provider to a user of the communication service provider. For example, the site 118 provides the ads 122 to Maria.

In box 1506, compensation from advertisers is optionally received for a communication service provider. For providing advertisements associated with the advertisers to a user of the communication service provider. For example, the site 118 receives compensation from advertisers for providing the ads 122 to Maria and other users of the site 118.

In box 1508, a user is optionally enabled to conduct a search of advertisements associated with advertisers. For example, the site 118 enables Maria to conduct a search of the ads 122 for vacuum cleaner ads.

In box 1510, a user is optionally provided with a compensation incentive explanation and/or a compensation incentive calculation example associated with an advertisement. For example, the site 118 informs Maria that the sponsor of her selected vacuum cleaner ad will pay her 4% of the vacuum cleaner's sales price for each of her friends that purchase the vacuum cleaner through the ad that she selected.

In box 1512, a selected advertisement is associated with a user communication by a communication service provider in response to a user selection to associate an advertisement with a user communication. For example, the site 118 links Maria's selected vacuum cleaner ad with her recommendation about the vacuum cleaner.

In box 1514, compensation is received from advertiser associated with a selected advertisement for a communication service provider in response to a determination that a recipient of a user communication committed an action associated with a selected advertisement. For example, the sponsor of the vacuum cleaner ad pays $32 to the site 118 because Susan purchased the vacuum cleaner through Maria's selected vacuum cleaner ad.

in box 1516, a portion of compensation is optionally provided to user. For example, the site 118 pays $16 to Maria because Susan purchased the vacuum cleaner through Maria's selected vacuum cleaner ad.

In box 1518, a recipient of a user communication is optionally enabled to choose an advertisement and associate the chosen advertisement with a recipient communication response. For example, the site 118 enables Trish to choose an ad and links Trish's chosen ad with her response to Maria's recommendation.

In box 1520, a user is optionally enabled to assign each advertisement in a compilation of advertisements to a corresponding category. For example, the site 118 enables Maria to generate the category “my favorite things and assign some of her ads to this category for one of her ad lists.

In box 1522, a recipient is optionally enabled to review a compilation of advertisements selected by a user and associated with other user communications. For example, the site 118 enables Susan to review the ad list for Maria's “favorite things”.

In box 1524, a user is optionally enabled to review a compilation of advertisements selected by users and associated with other user communications. For example, the site 118 enables Susan to review the ads 122 in a virtual “ad mall.” The method 1500 may be repeated as desired.

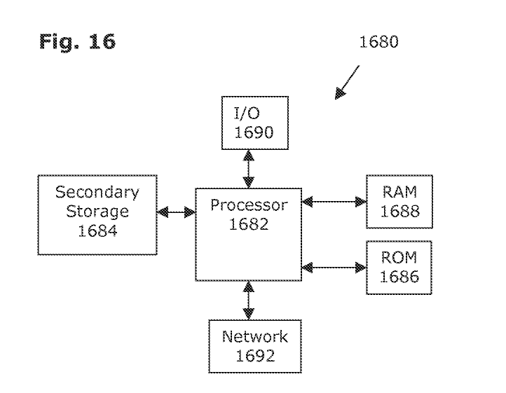

FIG. 16 illustrates a computer system 1680 suitable for implementing one or more embodiments disclosed herein. The computer system 1680 includes a processor 1682 (Which may be referred to as a central processor unit or CPU) that is in communication with memory devices including secondary storage 1684, read only memory (ROM) 1686, random access memory (RAM) 1688, input/output (I/O) devices 1690, and network connectivity devices 1692. The processor 1682 may be implemented as one or more CPU chips.

It is understood that by programming and/or loading executable instructions onto the computer system 1680, at least one of the CPU 1682, the RAM 1688, and the ROM 1686 are changed, transforming the computer system 1680 in part into a particular machine or apparatus having the novel functionality taught by the present disclosure. It is fundamental to the electrical engineering and software engineering arts that functionality that can be implemented by loading executable software into a computer can be converted to a hardware implementation by well known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions, may be viewed as a particular machine or apparatus.

The secondary storage 1684 is typically comprised of one or more disk drives or tape drives and is used for non-volatile storage of data and as an over-flow data storage device if the RAM 1688 is not large enough to hold all working data. Secondary storage 1684 may be used to store programs which are loaded into the RAM 1688 when such programs are selected for execution. The ROM 1686 is used to store instructions and perhaps data which are read during program execution. The ROM 1686 is a non-volatile memory device which typically has a small memory capacity relative to the larger memory capacity of the secondary storage 1684. The RAM 1688 is used to store volatile data and perhaps to store instructions. Access to both the ROM 1686 and the RAM 1688 is typically faster than to the secondary storage 1684.

The I/O devices 1690 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 1692 may take the form of moderns, modern banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LIE), worldwide interoperability for microwave access (WiMAX), and/or other air interface protocol radio transceiver cards, and other well-known network devices. These network connectivity devices 1692 may enable the processor 1682 to communicate with an Internet or one or more intranets. With such a network connection, it is contemplated that the processor 1682 might receive information from the network, or might output information to the network the course of performing the above-described method steps. Such information, which is often represented as a sequence of instructions to be executed using the processor 1682, may be received from and outputted to the network, for example, in the form of a computer data signal embodied in a carrier wave.

Such information, which may include data or instructions to be executed using the processor 1682 for example, may be received from and outputted to the network, for example, in the form of a computer data baseband signal or signal embodied in a carrier wave. The baseband signal or signal embodied in the carrier wave generated by the network connectivity devices 1692 may propagate in or on the surface of electrical conductors, in coaxial cables, waveguides, in an optical conduit, for example an optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, may be generated according to several methods well known to one skilled in the art.

The processor 1682 executes instructions, codes, computer programs, scripts which it accesses from hard disk, floppy disk, optical disk (these various disk based systems may all be considered the secondary storage 1684), the ROM 1686, the RAM 1688, or the network connectivity devices 1692. While only one processor 1682 is shown, multiple processors may be present. Thus, while instructions may be discussed as executed by a processor, the instructions may be executed simultaneously, serially, or otherwise executed by one or multiple processors.

In an embodiment, the computer system 1680 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 1680 to provide the functionality of a number of servers that is not directly bound to the number of computers in the computer system 1680. For example, virtualization software may provide 20 virtual servers on 4 physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein implementing the functionality disclosed above. The computer program product may comprise data, data structures, files, executable instructions, and other information. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 1680, at least portions of the contents of the computer program product to the secondary storage 1684, to the ROM 1686, to the RAM 1688, and/or to other non-volatile memory and volatile memory of the computer system 1680. The processor 1682 may process the executable instructions and/or data in part by directly accessing the computer program product, for example by reading from a CD-ROM disk inserted into a disk drive peripheral of the computer system 1680. The computer program product may comprise instructions that promote the loading and/or copying of data, data structures, files, and/or executable instructions to the secondary storage 1684, to the ROM 1686, to the RAM 1688, and/or to other non-volatile memory and volatile memory of the computer system 1680.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

1. A system for interactive advertising for computer mediated communications, the system comprising:
a computer;
a memory; and
a computer program stored in the memory and executed by the computer to:
provide an advertisement associated with an advertiser via a communication service provider to a user of the communication service provider;
associate a selected advertisement with a user communication by the communication service provider in response to a user selection to associate the advertisement with the user communication;
receive compensation from the advertiser for the communication service provider in response to a determination that a recipient of the user communication committed an action associated with the selected advertisement.

2. The system of claim 1, wherein the computer program provides the advertisement associated with the advertiser to the user of the communication service provider in response to receiving a user request to review a plurality of advertisements.

3. The system of claim 1, wherein the computer program is further executed by the computer to receive additional compensation from a plurality of advertisers for the communication service provider for providing a plurality of advertisements associated with the plurality of advertisers to the user of the communication service provider.

4. The system of claim 1, wherein the computer program is further executed by the computer to enable the user to conduct a search of a plurality of advertisements associated with a plurality of advertisers, and wherein the search is based on at least one of a category of at least one of a product and a service, a name of at least one of the product and the service, and an entity associated with at least one of the product and the service.

5. The system of claim 4, wherein enabling the user to conduct the search of the plurality of advertisements associated with the plurality of advertisers comprises initially presenting at least one featured advertisement to the user, and wherein the computer program is further executed by the computer to receive supplementary compensation from an advertiser associated with the featured advertisement for the communication service provider.

6. The system of claim 1, wherein the computer program is further executed by the computer to provide the user with at least one of a compensation incentive explanation and a compensation incentive calculation example associated with an advertisement.

7. The system of claim 1, wherein the user selection to associate the selected advertisement with the user communication is at least partially based on a compensation incentive offered by the advertiser associated with the selected advertisement.

8. The system of claim 1, wherein the computer program is further executed by the computer to enable the user to select presentation of the advertisement with presentation of the user communication.

9. The system of claim 1, wherein the selected advertisement comprises a small image depicting at least one of a product and a service, a name of at least one of the product and the service, a price associated with at least one of the product and the service, a sponsor associated with at least one of the product and the service, a description of at least one of the product and the service, a comment associated with at least one of the product and the service, compensation incentive information associated with at least one of the product and the service, and a number of users associating the selected advertisement with their user communications.

10. The system of claim 1, wherein the selected advertisement comprises a link associated with at least one of a review of at least one of a product and a service associated with the selected advertisement and an offer to purchase at least one of the product and the service associated with the selected advertisement.

11. The system of claim 1, wherein the user communication comprises at least one of a text communication, an audio communication, and a video communication.

12. The system of claim 1, wherein the action is at least one of viewing the selected advertisement, selecting to view the selected advertisement, selecting a link associated with the selected advertisement, and selecting to make a purchase associated with the link.

13. The system of claim 1, wherein the compensation is based on at least one of an individual purchase of at least one of a product and a service and a collective purchase that comprises at least one of the product and the service and at least one of another product and another service.

14. The system of claim 1, wherein the computer program is further executed by the computer to provide a portion of the compensation to at least one of the user and the recipient, wherein the portion of the compensation comprises at least one of a financial payment, a credit associated with a potential purchase, a reduction in expenses associated with the communication service provider, and an amount of uncharged services associated with the communication service provider.

15. The system of claim 1, wherein the computer program is further executed by the computer to enable the recipient of the user communication to choose an advertisement from a plurality of advertisements and to associate the chosen advertisement with a recipient communication response.

16. A computer implemented method for interactive advertising for computer mediated communications, the method comprising the steps of:
providing, by a computer program stored in a memory and executed by a computer, an advertisement associated with an advertiser via a communication service provider to a user of the communication service provider;
associating, by the computer program stored in the memory and executed by the computer, a selected advertisement with a user communication by the communication service provider in response to a user selection to associate the advertisement with the user communication;
receiving, by the computer program stored in the memory and executed by the computer, compensation for the communication service provider from an advertiser associated with the selected advertisement in response to a determination that a recipient of the user communication committed an action associated with the selected advertisement.

17. The computer implemented method of claim 16, further comprising enabling the recipient to review a compilation of a plurality of advertisements selected by the user and associated with other user communications.

18. The computer implemented method of claim 17, further comprising enabling the user to assign each advertisement in the compilation of the plurality of advertisements to a corresponding category, wherein reviewing the compilation of the plurality of advertisements is based on reviewing at least one of a plurality of corresponding categories.

19. The computer implemented method of claim 16, further comprising enabling the user to review a compilation of a plurality of advertisements selected by a plurality of users and associated with other user communications, wherein a presentation of the compilation of the plurality of advertisements selected by the plurality of users is at least partially based on a number of users associated with selecting each of the plurality of advertisements.

20. A computer program product for interactive advertising for computer mediated communications, the computer program product comprising:
a computer readable storage medium storing computer executable program code that, when executed by a processor, causes the computer executable program code to perform a method comprising the steps of:
providing an advertisement associated with an advertiser via a communication service provider to a user of the communication service provider;
associating a selected advertisement with a user communication by the communication service provider in response to a user selection to associate the advertisement with the user communication;
receiving compensation for the communication service provider from an advertiser associated with the selected advertisement in response to a determination that a recipient of the user communication committed an action associated with the selected advertisement.
